(19) United States
(12) Patent Application Publication
(10) Pub. No.: US 2006/0190339 A1
(43) Pub. Date: Aug. 24, 2006

(54) Policy-based store catalog synchronization

(75) Inventors: Yuen Ling Wan, Markham, Ontario (CA); Kwong Hung Yu, Markham, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 10/906,513

(22) Filed: Feb. 23, 2005

(51) Int. Cl. G06Q 20/00

(52) U.S. Cl. 705/22; 705/26

(57) ABSTRACT

A method, system and program product for policy-based navigational catalog synchronization. A method for policy-based store catalog synchronization can include applying inclusion rules to a node filter during a synchronization process between a store catalog and a navigational catalog. The applying step can include reading store-level product and category inclusion flags to determine whether to include product and category updates detected in the navigational catalog to the store catalog. In a particular aspect of the present invention, the applying step can include retrieving one or more log entries for updates to the navigational catalog and, for each log entry, reading store-level product and category inclusion flags to determine whether to include one of a product update and a category update to the store catalog.

### DESCRIPTION

1. Statement of the Technical Field

The present invention relates to the field of e-commerce and more particularly to catalog management in an e-commerce system.

2. Description of the Related Art

E-commerce systems have evolved to provide virtual storefronts whose operational capabilities far exceed those of the traditional, brick and mortar store. Whereas in the brick and mortar store, each of the sales, marketing, order fulfillment, inventory, and customer service functions remain the separate responsibilities of corresponding business roles, in a well-defined e-commerce system, each of the sales, marketing, order fulfillment, inventory and customer service can be integrated in a single computing system in a highly automated fashion. Consequently, a more optimal business operation can result in which data flows between different functional subsystems seamlessly to facilitate the daily conduct of business managed by the e-commerce system.

In the prototypical e-commerce system, an on-line catalog of available goods and/or services for sale can be established along with associated pricing. Customers can be provided with a store front user interface through which customers can browse the on-line catalog. When a customer desires to purchase a product or service, the customer can so indicate causing the addition of the selected product or service to an on-line shopping cart, though it is also known to bypass the shopping cart model in favor of direct purchase model.

The sales catalog allows the customers to browse for products. Conventionally known as a navigational catalog, it is a hierarchical map of categories having as an example, products, SKUs and kits. Notably, a store can have multiple sales catalogs and each can be organized for display to the customers, usually for merchandising purposes. Additionally, the sales catalog can have products assigned to multiple categories and a category can have more than one parent to form a map rather than a tree.

In the modern e-commerce environment, it is not uncommon for a large enterprise to subset a portions of its products for sale into many smaller electronic stores to improve sales because the smaller stores may be able to better market to specific audiences with customized catalogs. Further, the smaller stores often have navigation catalogs of their own. To reduce catalog maintenance effort, a master catalog often can be created such that non-audience specific product information can be shared among the many smaller stores with tailored information that may be part of a navigational catalog. As the product line increases in size, new categories of products can be created and the navigational catalog of a store quickly can fall out of synchronization. In consequence, catalog maintenance can be required in order to resynchronize the catalog. Thus, to manage store navigational catalogs manually can become costly.

### SUMMARY OF THE INVENTION

The present invention addresses the deficiencies of the art in respect to catalog management in an e-commerce system and provides a novel and non-obvious method, system and apparatus for policy-based navigational catalog synchronization. A method for policy-based store catalog synchronization can include applying inclusion rules to a node filter during a synchronization process between a store catalog and a navigational catalog. The applying step can include reading store-level product and category inclusion flags to determine whether to include product and category updates detected in the navigational catalog to the store catalog.

In a particular aspect of the present invention, the applying step can include retrieving one or more log entries for updates to the navigational catalog and, for each log entry, reading store-level product and category inclusion flags to determine whether to include one of a product update and a category update to the store catalog. More specifically, the reading step can include determining whether a child listed in the log entry is a product or a category. If the child is a product and if the store-level product inclusion flag is set to ON, or if the child is a category and if the store-level category inclusion flag is set to ON, the child can be added to the store catalog only if a category flag for a parent to the child listed in the log entry is set to ON. Otherwise the child can be excluded from the store catalog.

In another aspect of the invention, the method can include favoring inclusion to the store catalog of one of an addition and a modification to a path between a parent category and a child reflected in an update to the navigational catalog. Similarly, the method can include favoring exclusion from the store catalog of one of an addition and a modification to a path between a parent category and a child reflected in an update to the navigational catalog. The method yet further can include the step of deferring to a defined exclusion set when processing one of an addition and a modification to a path between a parent category and a child reflected in an update to the navigational catalog. As yet another option, the method can include the step of deferring to an inclusion policy for a real parent to a child listed in the log entry for processing one of an addition and a modification to a path between a parent category and a child reflected in an update to the navigational catalog.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and, together with the description, serve to explain the principles of the invention. The embodiments illustrated herein are presently preferred, it being understood, however, that the invention is not limited to the precise arrangements and instrumentalities shown, wherein:

FIG. 1 is a schematic diagram depicting an e-commerce system configured for policy-based catalog synchronization in accordance with the present invention;

FIG. 2 is a flow chart illustrating a process for policy-based catalog synchronization;

FIG. 3 is a flow chart illustrating a process for handling a synchronization policy which favors the inclusion of a product during the policy-based catalog synchronization process of FIG. 2;

FIG. 4 is a flow chart illustrating a process for handling a synchronization policy which favors the exclusion of a product during the policy-based catalog synchronization process of FIG. 2;

FIG. 5 is a flow chart illustrating a process for handling a synchronization policy which favors the inclusion/exclusion policy for a real parent in determining whether to include or exclude a product during the policy-based catalog synchronization process of FIG. 2;

FIG. 6 is a flow chart illustrating a process for handling a synchronization policy which favors the inclusion/exclusion policy for products specified in an exclusion set during the policy-based catalog synchronization process of FIG. 2; and,

FIG. 7 is a flow chart illustrating a process for handling a synchronization policy which considers the synchronization of a category during the policy-based catalog synchronization process of FIG. 2.

### DETAILED DESCRIPTION OF THE PREFERRED EMBODIMENTS

The present invention is a method, system and apparatus for the policy-based synchronization of a store catalog in an e-commerce system. In accordance with the present invention, one or more synchronization rules can be applied when periodically synchronizing a store catalog with a remote catalog such as a master catalog or a global navigational catalog. The rules can be associated with or incorporated within a node filter. Moreover, the rules can defer to store-level preferences for the store catalog irrespective of the category-level rules. The rules can be applied during either a periodic synchronization operation, or during a manually-specified synchronization operation.

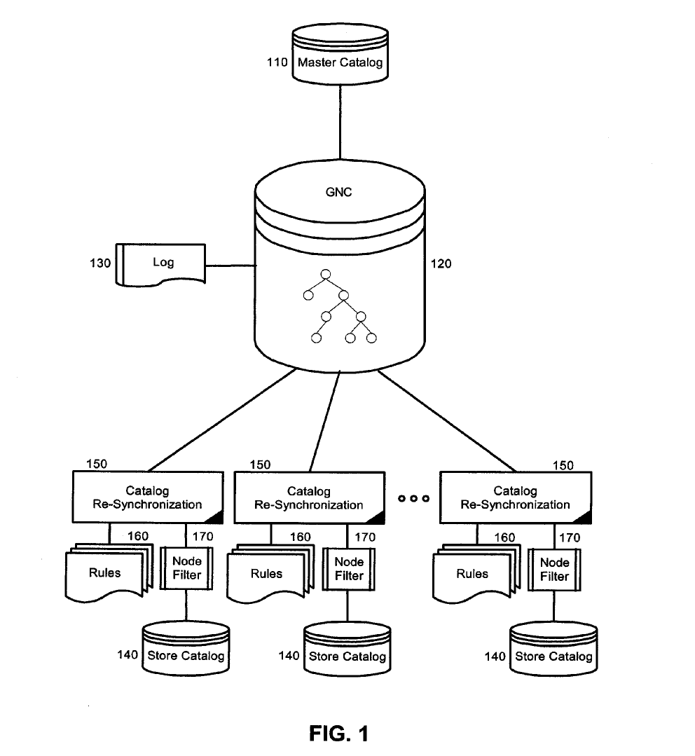

In more specific illustration of the inventive arrangements, FIG. 1 is a schematic diagram depicting an e-commerce system configured for policy-based catalog synchronization in accordance with the present invention. As shown in FIG. 1, the e-commerce system can include a catalog infrastructure which can include a master catalog 110 communicatively coupled to one or more store catalogs 140. Optionally, the master catalog 110 can be incorporated as part of a three-tier catalog system which can include a global navigational catalog 120 disposed between the master catalog 110 and the store catalogs 140.

In this regard, the master catalog 110 can include a well-formed tree of product categories and products and substantial product detail can be included. The global navigational catalog 120, by comparison, can be an encompassing graph of category and product nodes where the nodes can be visited along paths defining relationships amongst categories and between categories and products. Finally, the store catalogs 140 can be logical catalogs whose contents are filtered portions of the global navigational catalog 120. As such, each store catalog can include a node filter 170 associated with one or more inclusion rules 160. The inclusion rules can specify which products and categories in the global navigational catalog 120 can be viewed by shoppers accessing a corresponding one of the store catalogs 140.

More particularly, the inclusion rules 170 can govern how the node filters 170 are to be managed in an effective manner according to selected paradigms. For example, in one paradigm, the inclusion rules 170 can specify that new products and categories under a specific category are to be automatically included in the store catalog 140 when the master catalog 110 expands. In an alternative paradigm, the inclusion rules 170 can specify that new products and categories under a specific category are not to be automatically included in a store catalog 140 when the master catalog 110 expands. In either case, the inclusion rules 170 can be activated by a setting a flag for the store catalog 140.

Notably, from time to time the content and structure of the global navigational catalog 120 can change as maintenance is performed either directly upon the global navigational catalog 120, or indirectly based upon modifications to the master catalog 110. Consequently, catalog re-synchronization logic 150 can be associated with each store catalog 140 to ensure that the content of the store catalog 140 remains in sync with that of the global navigational catalog 120 or the master catalog 110 as the case may be. To facilitate the identification of modifications to the global navigational catalog 120, a log 130 of modifications can be generated. During the operation of the catalog re-synchronization logic 150, the log 130 can be consulted to identify new products and categories which have been added to the master catalog 110. Subsequently, the inclusion rules 160 can be applied to the changes indicated by entries in the log 130 to determine whether to include or exclude new products and categories in a respective one of the store catalogs 140.

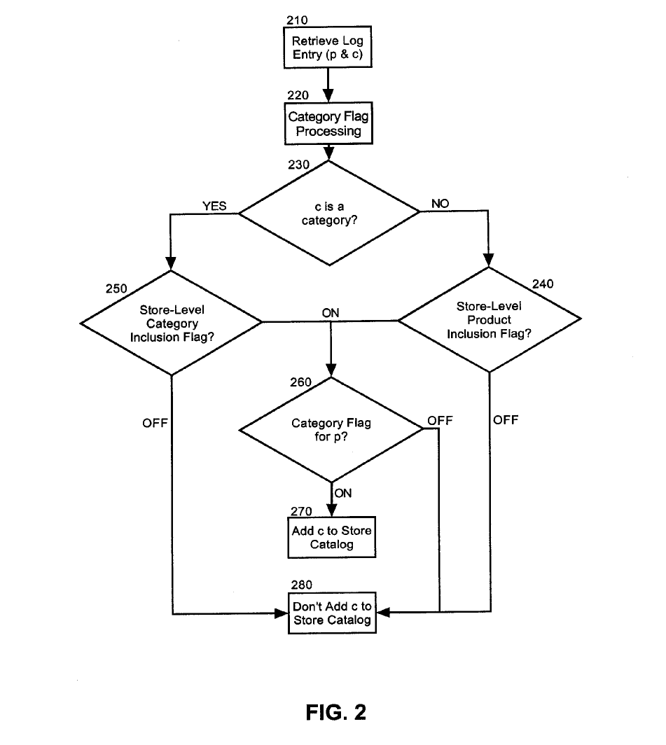

Turning now to FIG. 2, a flow chart is shown which illustrates a process for policy-based catalog synchronization. In the basic policy-based catalog synchronization process, a category flag can be set which determines whether new products or categories are to be automatically included in or excluded from the store catalog. Beginning in block 210, a log entry can be retrieved for a node in the global navigational catalog which can indicate either a category-to-product path, or a category-to-category path. Thus, each path can include a parent category and a child node, which child node can be a product or another category. The log entry also can include an indication of whether the child node is a product or category, and also a time stamp indicating when the addition or modification to the global navigational catalog had been performed.

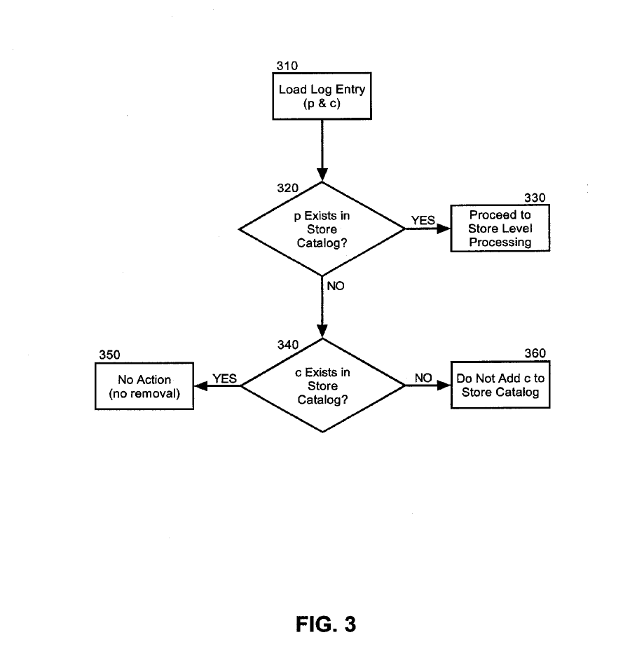

In block 220, the log entry can be pre-processed according to inclusion rules for children products and categories. A more detailed discussion of the pre-processing step will be deferred in reference to FIGS. 3 through 7. In any event, in decision block 230, it can be determined whether the child is a category. If so, the store-level category flag can be inspected to determine if the flag is ON or OFF. If the flag is OFF, indicating the automatic exclusion of new categories, in block 280 the child is not added to the store catalog. Similarly, if in decision block 240 it is determined that a store-level product flag is OFF, in block 280 the child is not added to the store catalog. In both cases, however, if the store-level flags permit, in decision block 260, if an additional category flag has been set ON for the parent of the child, in block 270 the child can be added to the store catalog. Otherwise, in block 280, the child is not added to the store catalog.

Notwithstanding the universal inclusion rules specified by the store-level flags and the parent category flag, log entries can be evaluated according to category-level flags, though the store-level flags take precedence over the category-level flags. Several inclusion paradigms can be implemented at the category level. For instance, the category-level inclusion rules can favor the inclusion or the exclusion of a new product or category based upon specific category settings, the settings for an explicit set of products and categories, and rules inherited from parent categories in the catalog, to name a few.

In further illustration, FIG. 3 is a flow chart illustrating a process for handling a synchronization policy which favors the implicit inclusion of a product during the policy-based catalog synchronization process of FIG. 2. Beginning in block 310, a log entry can be loaded and, in decision block 320, it can be determined whether the parent category exists in the store catalog. If so, the store-level processing of the log entry as shown in FIG. 2 can proceed in block 330. Otherwise, in decision block 340 it can be determined whether the child exists in the store catalog, albeit as part of a different category than the category referenced in the log entry. If not, the child is not added to the store catalog in block 360. Moreover, even if the child indeed exists in the store catalog, no action is to be taken. In this way, if at least one of the child's parents are defined in the store catalog, there is a way to browse to the child node such that the child node ought to be included in the store catalog.

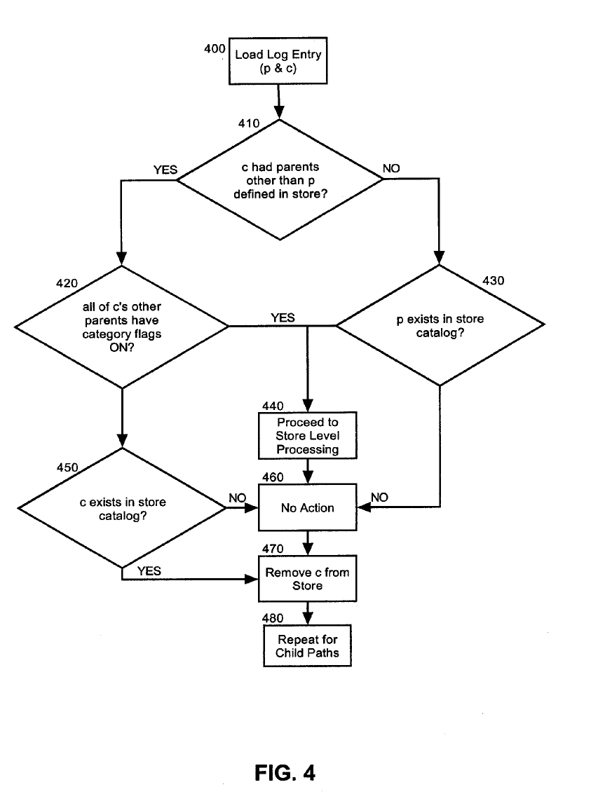

Unlike the process of FIG. 3, the process shown in FIG. 4 is a process for handling a synchronization policy which favors implicit exclusion of a product during the policy-based catalog synchronization process of FIG. 2. Beginning in block 400, a log entry can be loaded and, in decision block 410, it can be determined whether the child has parents in the store catalog other than the parent referenced in the log entry. If not, in block 430 it can be further determined whether the parent referenced in the log entry already exists in the store catalog. Again, if not, in block 460 no action is to be taken. Otherwise, store-level processing of the log entry as shown in FIG. 2 can proceed in block 440. In this way, the product in an update is guaranteed to be included if there is at least one browsing path to the product.

Still, if in decision block 410 it is determined that the child does have parents included in the store catalog other than the parent listed in the log, in decision block 420 it can be determined if all of the other parents are associated with category flags in the ON position. If so, store-level processing of the log entry as shown in FIG. 2 can proceed in block 440. If not, in decision block 450 it can be determined if the child exists in the store catalog. If not, no action is to be taken in block 460. However, if so, in block 470 the child can be removed from the store catalog in order to enforce the category flag for one or more of the child's parents. Furthermore, the foregoing process can be repeated in block 480 for all child paths.

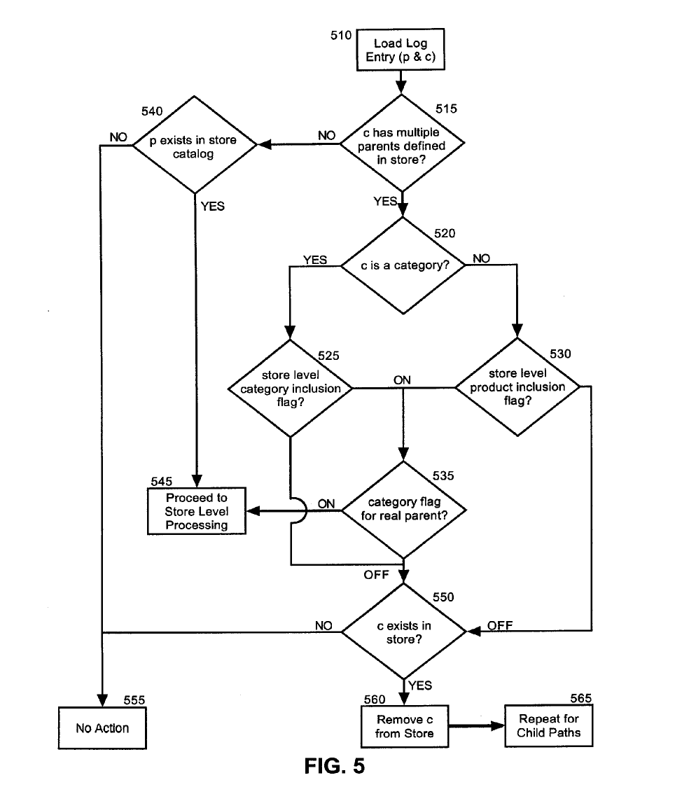

More complex arrangements further can be implemented in the category level inclusion rules. For example, FIG. 5 is a flow chart illustrating a process for handling a synchronization policy which defers to the inclusion/exclusion policy for a real parent in determining whether to include or exclude a product during the policy-based catalog synchronization process of FIG. 2. Beginning in block 510, a log entry can be loaded. In decision block 515 it can be determined if the child has multiple parents defined in the store catalog. If not, in decision block 540 it can be further determined if the parent of the child exists in the store catalog. If not, no action is to be taken. Otherwise, if so, store-level processing of the log entry as shown in FIG. 2 can proceed in block 545.

In decision block 515, if it is determined that the child indeed has multiple parents defined in the store catalog, in decision block 520 it can be determined whether the child is a category or a product. If the child is determined to be a category, in decision block 525 the store-level category inclusion flag can be checked. Similarly, if the child is determined to be a product, in decision block 530 the store-level product inclusion flag can be checked. In either case, if the store-level flag is determined to be ON, in decision block 535 the category flag for the real parent (as opposed to any virtual parents in the global navigational catalog) can be checked.

If ON, in block 545, store-level processing can proceed. Otherwise, if the flag for the real parent of the child, or if any of the store-level processing flags are set to OFF, in decision block 550 it can be determined whether the child exists in the store catalog. If not, no action is to be taken in block 555. Otherwise, in block 560 the child can be removed from the store catalog. Subsequently, in block 565, the process can be repeated recursively for the child paths of the child.

Utilizing the foregoing approach, all inclusion/exclusion settings can be stored in the master catalog and the decision to include or exclude a child can obey the rules associated with the real parent if the child has multiple parents defined in the store catalog. The only case where the child is to obey the settings of a virtual parent is where the virtual parent is the only parent of the child defined in the store catalog. It is an advantage of the approach of FIG. 5 that a brand of products can be excluded from the store catalog.

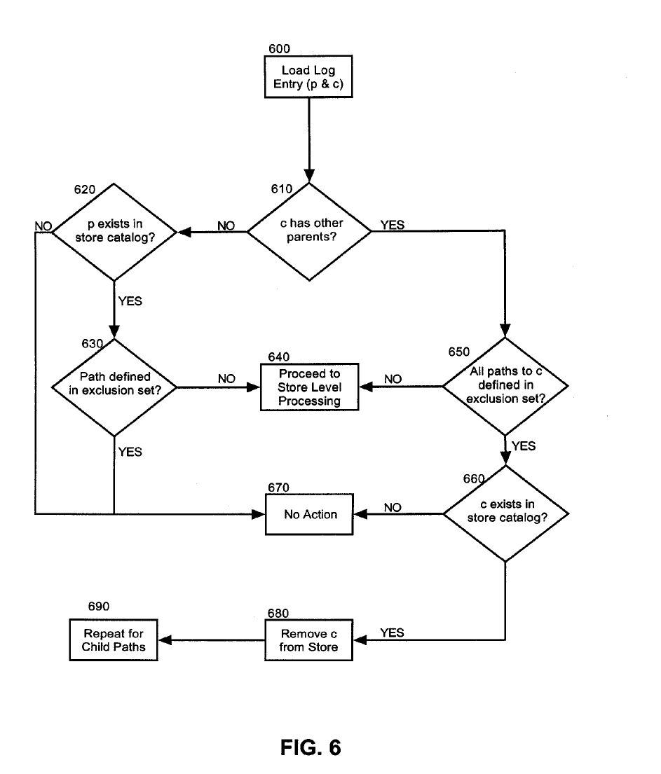

Importantly, in one inclusion/exclusion paradigm, an exclusion set can be defined to store all paths to be excluded from the store catalog. In this regard, FIG. 6 is a flow chart illustrating a process for handling a synchronization policy which defers to the inclusion/exclusion policy for products specified in an exclusion set during the policy-based catalog synchronization process of FIG. 2. Beginning in block 600, a log entry can be loaded and in decision block 610, it can be determined whether the child has parents defined in the store catalog other than the parent specified in the log entry. If not, in decision block 620 it can be determined if the parent exists in the store catalog. Again, if not, in block 670 no action can be taken. Otherwise, in block 630 it can be determined if the path between the parent and child has been defined within an exclusion set of paths. If so, no action can be taken in block 670. Otherwise, store-level processing can proceed in block 640.

If, in block 610, it is determined that the child has parents other than the parent denoted in the log entry, in decision block 650 it further can be determined if all paths to the child have been defined in the exclusion set. If not, again store-level processing can proceed in block 640. Otherwise, in decision block 660 it yet further can be determined whether the child exists in the store catalog. If not, no action need be taken in block 670. However, if the child does exist in the store catalog, in block 680 the child can be removed from the store catalog and the process can repeat for child paths in block 690.

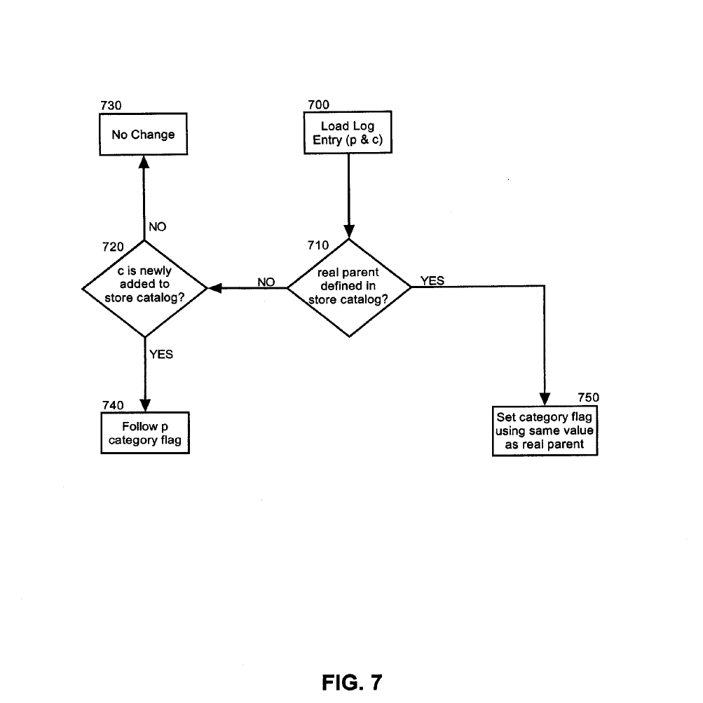

Optionally, every category that is determined to be included in the store catalog can inherit the category flag setting of its real parent category as defined in the master catalog. If the real parent category is not defined in the store catalog, and if the child category is new to the store, it will follow the category inclusion flag setting of its only virtual parent. Otherwise, if the child category is already defined in the store catalog, its category inclusion flag is already set and this setting will not be changed. In more particular illustration, FIG. 7 is a flow chart illustrating an inclusion rule for updated categories during the policy-based catalog synchronization process of FIG. 2.

Beginning in block 700, a log entry can be loaded and in decision block 710, it can be determined whether the real parent to the child in the log entry is defined in the store catalog. If so, the category flag to the child can be set using the same value as the category flag to the real parent in block 750. On the other hand, if in decision block 710 it is determined that the real parent to the child in the log entry is not defined in the store catalog, in decision block 720 it can be determined whether the child has been newly added to the store catalog. If not, no change is warranted in block 730. Otherwise, the category flag of child can be set using the same value as the category flag to the parent in block 740.

The inclusion or exclusion of a product or category during a re-synchronization process can be defined for any category found within the store catalog. The granularity of automatic re-synchronization is defined at the category level without the need to have product sets defined for each category. Moreover, the inclusion definitions are defined against the store catalog used by the shopper for navigation. Additionally, in that the store catalog supports multiple parent categories, special considerations are required to handle potential conflicts arising from different inclusion rules from different parent categories.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for policy-based store catalog synchronization, the method comprising the step of applying inclusion rules to a node filter during a synchronization process between a store catalog and a navigational catalog.

2. The method of claim 1, wherein said applying step comprises the step of reading store-level product and category inclusion flags to determine whether to include product and category updates detected in said navigational catalog to said store catalog.

3. The method of claim 1, wherein said applying step comprises the steps of:
retrieving a plurality of log entries for updates to said navigational catalog; and,
for each log entry, reading store-level product and category inclusion flags to determine whether to include one of a product update and a category update to said store catalog.

4. The method of claim 3, wherein said reading step comprises the steps of:
determining whether a child listed in said log entry is a product or a category;
if said child is a product and if said store-level product inclusion flag is set to ON, or if said child is a category and if said store-level category inclusion flag is set to ON, adding said child to said store catalog if a category flag for a parent to said child listed in said log entry is set to ON; and,
otherwise excluding said child from said store catalog.

5. The method of claim 3, further comprising the step of favoring inclusion to said store catalog of one of an addition and a modification to a path between a parent category and a child reflected in an update to said navigational catalog.

6. The method of claim 3, further comprising the step of favoring exclusion from said store catalog of one of an addition and a modification to a path between a parent category and a child reflected in an update to said navigational catalog.

7. The method of claim 3, further comprising the step of deferring to a defined exclusion set when processing one of an addition and a modification to a path between a parent category and a child reflected in an update to said navigational catalog.

8. The method of claim 3, further comprising the step of deferring to an inclusion policy for a real parent to a child listed in said log entry for processing one of an addition and a modification to a path between a parent category and a child reflected in an update to said navigational catalog.

9. A system for policy-based store catalog synchronization comprising:
a master catalog communicatively coupled to a plurality of store catalogs;
a set of inclusion rules and a node filter for each of said store catalogs; and,
catalog re-synchronization logic coupled to each of said store catalogs and configured to apply a node filter governed by said inclusion rules when synchronizing with said master catalog.

10. The system of claim 9, further comprising a global navigational catalog disposed between said store catalogs and said master catalog.

11. The system of claim 9, further comprising a log of changes performed to said master catalog.

12. They system of claim 10, further comprising a log of changes performed to said global navigational catalog.

13. A machine readable storage having stored thereon a computer program for policy-based store catalog synchronization, the computer program comprising a routine set of instructions which when executed by a machine cause the machine to perform the step of applying inclusion rules to a node filter during a synchronization process between a store catalog and a navigational catalog.

14. The machine readable storage of claim 13, wherein said applying step comprises the step of reading store-level product and category inclusion flags to determine whether to include product and category updates detected in said navigational catalog to said store catalog.

15. The machine readable storage of claim 13, wherein said applying step comprises the steps of:
retrieving a plurality of log entries for updates to said navigational catalog; and,
for each log entry, reading store-level product and category inclusion flags to determine whether to include one of a product update and a category update to said store catalog.

16. The machine readable storage of claim 15, wherein said reading step comprises the steps of:
determining whether a child listed in said log entry is a product or a category;
if said child is a product and if said store-level product inclusion flag is set to ON, or if said child is a category and if said store-level category inclusion flag is set to ON, adding said child to said store catalog if a category flag for a parent to said child listed in said log entry is set to ON; and,
otherwise excluding said child from said store catalog.

17. The machine readable storage of claim 15, further comprising an additional set of instructions for causing the machine to further perform the step of favoring inclusion to said store catalog of one of an addition and a modification to a path between a parent category and a child reflected in an update to said navigational catalog.

18. The machine readable storage of claim 15, further comprising an additional set of instructions for causing the machine to further perform the step of favoring exclusion from said store catalog of one of an addition and a modification to a path between a parent category and a child reflected in an update to said navigational catalog.

19. The machine readable storage of claim 15, further comprising an additional set of instructions for causing the machine to further perform the step of deferring to a defined exclusion set when processing one of an addition and a modification to a path between a parent category and a child reflected in an update to said navigational catalog.

20. The machine readable storage of claim 15, further comprising an additional set of instructions for causing the machine to further perform the step of deferring to an inclusion policy for a real parent to a child listed in said log entry for processing one of an addition and a modification to a path between a parent category and a child reflected in an update to said navigational catalog.
